(19) United States
(12) Patent Application Publication
(10) Pub. No.: US 2006/0011134 A1
(43) Pub. Date: Jan. 19, 2006

(54) Monitoring and rejection system and apparatus

(76) Inventors: John Wain, Keilor Downs (AU); Murray Dicker, Lilydale (AU)

Correspondence Address: OLIFF & BERRIDGE, PLC, P.O. BOX 19928, ALEXANDRIA, VA, 22320, US

(21) Appl. No.: 10/787,189

(22) Filed: Feb. 27, 2004

Related U.S. Application Data
(63) Continuation of application No. PCT/AU02/01215, filed on Sep. 4, 2002.

(30) Foreign Application Priority Data
Sep. 4, 2001 (AU) PR7491
Mar. 28, 2002 (AU) 29297/02

(51) Int. Cl. B05C 11/00

(52) U.S. Cl. 118/668

(57) ABSTRACT

A monitoring system checks for correct application of adhesive tracks 6 to e.g. the flap 2 df a cardboard blank 1 on a conveyor system. It includes sensors 14,15 for detecting the position of the blank 1, and a central controller 18 for triggering a camera 16 to take one or more images of the blank 1 at suitable times after the blank 1 is detected, e.g. using the output of an encoder 17. The images may be taken at the expected start, middle and end of the tracks 6, and are analysed by the controller 8 to check for correct application of the tracks 6. The controller 8 and sensors 14,15 can also be used to initially set the dimensions of the blank 1, and the controller 8 can also track a failed blank 1 and reject it later in the conveyor system.

The present invention relates to monitoring and rejection systems and apparatus. It relates particularly, though not exclusively, to a monitoring system for monitoring the application of adhesive to an item, e.g. the application of glue to a cardboard blank for making a box or the like, and to rejection apparatus and systems for rejecting items from a product line.

In a typical process for manufacturing cardboard boxes and the like, a blank is cut from a length of cardboard and conveyed to a gluing station where tracks of glue are applied to one or more flaps of the blank. The blank is then conveyed to a folding frame, where it is folded to produce a box, with the pre-glued flaps forming joints with corresponding landing portions of the blank.

In such a process, problems can occur if the glue is not accurately applied to the blank. For example, if not enough glue is applied to a flap, then the flap may not adhere properly to its landing portion, and the box may not retain its structure. Alternatively, if too much glue is applied or is applied in a wrong position, then excess glue may exude from the flap-landing joints and may cause the box to stick to other boxes when they are stacked together at the end of the production line.

Various methods are currently used to monitor the application of glue to a cardboard blank.

In these methods, once a blank reaches a monitoring station, a glue sensor is switched on when the start of a correctly positioned glue track should pass over the sensor, and is switched off when the end of the glue track should pass over the sensor. The sensor thus monitors the presence or absence of glue along the glue track from its expected start to its expected finish, and identifies situations in which glue tracks do not exist or are incomplete.

In one of these methods, a UV dye is included in the glue, and light is shone onto the glued blank. A photoelectric sensor is then used to sense the existence of a glue track from the reflected light. A problem with this method, however, is that when a blank is provided with a white liner, e.g. when producing fruit boxes, the liner can itself reflect a significant amount of light, and so may provide false readings, e.g. to indicate that a glue track is present when it is not.

In another method, a moisture sensor is used to determine the present or absence of a track of a water-based glue, the track's presence being determined by a high moisture content reading from the sensor. A problem, however, is that cardboard is generally manufactured from a number of separate layers of paper material that are layered together by starch and heat, the latter being in the form of steam. This process can produce cardboard with inherently high moisture content, and, if the cardboard is not allowed to sit for a sufficient time in order to dry, the moisture sensor may falsely indicate the presence of glue because of the moisture content of the cardboard.

A third method is to use a laser beam and photocell. This can, however, produce erratic results, as even small movement of the blank on the conveyor can disrupt measurements.

A problem with all of the above methods is that they merely attempt to detect that a glue track is continuous from the point at which the sensor is switched on to the point at which it is switched off. Thus, none of the systems test to determine whether or not there is an excess of glue, e.g. extending before and/or after the start and finish of the glue track.

The present invention aims to provide an adhesive monitoring system to address such problems.

Viewed from a first aspect, the present invention provides an adhesive monitoring system for monitoring the application of adhesive to an item, wherein the system includes means for determining the position of the item on a production line, camera means for taking an image of a monitored item, means for triggering the camera means to take an image of the item at one or more set item positions, and processing means for analysing the images produced and for determining the correct application of adhesive from this analysis.

By taking an image of the blank or part thereof and using a camera and image processing technology, the present invention can provide reliable sensing of e.g. an adhesive track on a cardboard blank.

The extent of the track can also be analysed to determine if too much adhesive has been applied.

The analysis of the images produced by the camera may take any suitable form.

In one preferred embodiment, images taken by the camera means are compared with reference images of items that have correctly applied adhesive thereon. The degree of agreement of the two images can then be used to assess whether glue has been applied acceptably to an item.

In another possible analysis, features of the image may be recognised by suitable recognition analysis, e.g. edge features, and these features may be measured or the like, and the measurements compared with set values.

During analysis, the intensity, colour and/or other aspects of an image portion or pixel may be determined in order to make these comparisons and/or feature identifications. These determinations may be made using absolute values, and/or using relative values that can then mitigate against changes in ambient light conditions.

In one embodiment, reference images may be taken, and intensity profiles or the like of the image may be obtained along one or more lines of measurement. Similar profiles of camera-sampled images may then be taken along corresponding measurement lines, and compared with the reference profiles.

These measurement lines may be orientated in any direction within the image, and may be horizontal across the image to assess e.g. the beginning and end point of a glue track and/or vertical across the image to assess e.g. the number, width and relative positions of the tracks with respect to one another.

This highlights another advantage of the present invention, which is that it allows two-dimensional monitoring. Thus, it can monitor a glue track's width as well as its length. Furthermore, it may be that two or more parallel glue tracks are applied to the item, and the image may be analysed to count the number of tracks. To do this with the prior art sensors would require the use of a number of sensors and would require that the sensors were added, removed and repositioned with respect to one another for different glue track arrangements.

The transverse distance of a glue track from a longitudinal edge of the blank, e.g. from an edge of a flap, may also be monitored, so as to ensure that the track is not skewed with respect to the edge. When a blank is not adequately held firm on going through a contacting glue head, it can become displaced, so that when the glue is applied through the head, the glue tracks will remain parallel to one another but will be skewed with respect to their required position. The present invention allows this to be detected.

Although a single image of a whole item may be taken and processed, it is preferred to image one or more smaller portions of the monitored item. This provides flexibility in the size of the item to be monitored. For example, if the whole of an item were to be monitored, then the camera would need to be repositioned further away or nearer to the item dependant on item size in order to accommodate the item within the camera's image area.

Preferably, an image is taken at the expected start of the adhesive, e.g. at the start of one or more glue tracks, and at the expected end of the adhesive.

Preferably also, one or more further intermediate images are taken dependant on the extent of the adhesive. This will depend e.g. on the length of the glue track and the size of the area imaged per camera shot. For example, a glue track may need only one image in total if it is sufficiently small, or if larger, may need one image taken at each end, and perhaps one or more intermediate images taken in the middle portions of the track.

By using a number of small camera images of the item, the system can accommodate items such as cardboard blanks of varying length by varying the number of images taken.

The system may include a sensor, such as a photosensor or some other trip-switch type device to indicate that an item to be monitored has reached a set position along a conveyor belt. This may be achieved e.g. by sensing the leading edge of the item, e.g. cardboard blank.

The system may then instruct the camera to take a picture based on the sensing of the item. This may for example be at a set time after the sensor is activated. For example, the system may know the speed of the conveyor system or the like and the distance that the monitored areas of an item are from a leading edge of the item, e.g. the position at which a correctly applied glue track would start. It will accordingly instruct the camera to take an image at one or more times during the passing of the item passed the camera, e.g. when it calculates that an appropriate portion of a correctly applied glue track should be within the imaged area, e.g. the start, middle and/or end of the track.

In an alternative embodiment, the system includes an encoder or the like (e.g. in the drive system of the conveying means) which produces timing pulses dependent on the speed of the conveyor, so that the distance a conveyor has moved along its path can be determining. The system can thus instruct the camera to take an image when the encoder indicates that the conveyor has moved one or more set distances after the item was initially sensed.

The item may have other features that need to be checked, besides adhesive positioning, and the present invention is able to monitor this also, simultaneously with checking for e.g. glue tracks. For example, a box blank may comprise a rectangular sheet that has a rectangular tab portion cut out of opposing corners so as to provide a rectangular flap therebetween. The present invention not only can detect glue tracks on the flap, but can also check whether the tabs were fully removed or not. Thus, the system may detect a difference between a reference image without a tab, and a detected image in which a portion of the tab is still on the blank, (the intensity in this portion of the image will be significantly different from that of the reference image).

The present invention may be applied to a conveyor line or to any other similar system in which items are moved along a manufacturing/production line and need to be monitored for correct glue application.

It should be noted that the glue tracks may not be on e.g. a flap of a cardboard blank or other item, but could instead be on a landing portion to which a flap attaches, and the camera should be mounted suitably dependent on this. The camera may be movable in position transverse to the manufacturing line for imaging appropriate portions of the item to be monitored.

Preferably, the camera is moved with movement of the adhesive application means of the system. This may be through separate movement means that are commanded in their movement by a central control, or by physically or mechanically connecting the camera and adhesive applicator together, e.g. by mounting them on the same mounting means.

When an item is located which does not conform to the required specifications, e.g. the glue track is discontinuous or extends past the correct start and finish points, then various indications of this may be provided, and various actions may be taken.

In one preferred form, the blank is marked, e.g. by a dye so that it can be recognised and removed by an operator. This may occur e.g. at the end of the production line, where the boxes are stacked together. Identification could for example use a water-based dye or an ultra-violet spray system, and the item could be removed in an ultra-violet light inspection area. The item should preferably be marked in a suitable location such that the dye can be seen by an operator when the item is stacked or otherwise stored.

In a preferred embodiment, when the system identifies an item that should be rejected, it tracks the item, and ejects the item from the production line at a suitable location.

Tracking may for example be achieved by monitoring the output of an encoder or the like which tracks the amount of movement of a conveyor means, e.g. belt or the like, about its path, so as to know how far the item has moved since being imaged. Thus, the system can determine when the item has reached a suitable rejection point.

In one preferred embodiment, the system records each pass or fail in a memory location, e.g. as a “1” or “0”, and at each timing pulse of an encoder or after a set number of timing pulses (or using any other suitable count), the controller increments the address for each record. The addresses can then correspond with set positions of the production line, and the system can check, at set intervals, the record held in the memory location that is associated with the rejection location of the production line, and can activate the rejection apparatus when the record in that memory location is a fail record.

The manner of rejection may take any suitable form. In one preferred embodiment, rejection is provided by an impeller arm that urges the item off of the conveyor or the like. In a particularly preferred form, the rejection device comprises a trap door which opens to drop a rejected item into a reject bin, and which closes to allow accepted items to pass across. Any other suitable diversion means could also be used.

When a rejection occurs, the system may increment a count of consecutive fails, and may take suitable action, such as to stop the production line and/or issue an alarm, when the count reaches a preset threshold, which could indicate an abnormal condition, such as a sensor or camera failure or the like.

Furthermore, the system may keep a running total of failures, and may discriminate between various types of failure and provide separate counts for each, e.g. for certain types of glue track failure and/or flap tab failures.

The present invention may be provided in a production line on installation of the line, or may take the form of a retrofit kit.

The system may include an overall controller which receives the input from the camera and from the processing means, together with sensor information and user input. The controller may for example be in the form of a computer system. Preferably, the controller takes the form of a Programmable Logic Controller (PLC).

The controller may include input means for allowing operator input, such as a keypad, touch screen or the like.

An important feature of the present invention is that it preferably includes means for obtaining the dimensions of an item to be monitored by first passing a correctly configured item through the monitoring system.

Thus, in a preferred embodiment, a sensor determines the leading and following edges of an item as it moves past the sensor, and determines the dimension of the item in this direction.

More than one sensor may be provided if the profile of the item varies in a direction transverse to the feed direction. For example, if the item includes a flap element, then the system may include a sensor to note the main leading and trailing edges of the item, and a sensor to note the leading and/or trailing edges of the flap portion.

Thus, the system can determine the various leading and trailing edges of the item, and can calculate the item's length, its flap positions and the like.

This information can then be displayed to an operator, e.g. through a suitable display such as a touch screen, and the operator can confirm that the dimensions are correct, and that it should be used as a template for further measurements.

Preferably, the system shuts down the feed of blanks if the operator does not accept the dimensions. This is to prevent blanks being fed through the system without any monitoring.

Preferably, the system has stored therein a set offset for the correct start and/or finishing position of an adhesive track relative to the measured edges (e.g. an offset from the leading and/or trailing edge of the item), and so once it has the above information, the system can calculate when to take images of the item with the camera means in accordance with the expected position of the glue track.

In prior art systems, an operator was required to manually input the start and end positions of a glue track with respect to the leading edge of a blank into a dedicated controller using thumbwheels. Such inputs are prone to error, and a mistake in the input could compromise a whole run of produced boxes.

In accordance with the present system, however, When e.g. a cardboard blank is monitored, the system determines the dimensions of the blank, e.g. its length, the offset of the leading edge of the flap from the main leading edge, and the flap length. From this, and from a preset offset by which the glue track is to be inwardly spaced from the leading and trailing edges of the flap, the system can calculate the start point of the glue track from the main leading edge and the end point of the glue track from the main leading edge. It can then activate the camera appropriately to take an image at the points when it has calculated that a correctly applied glue track should appear.

The camera may take any suitable form, and may comprise a video camera. The camera may be black and white or colour, and may provide a digital image, or may provide an analogue output that is then suitably digitised. The camera may have no or minimal processing means therein for analysing the images taken, in which case the system controller may do this, or the camera may include processing means therein for analysing the images, and may output for example a pass or fail signal to the controller based on this.

The camera may for example comprise a SmartImage Optical vision camera from DVT Corporation, Georgia, USA.

The invention extends to a production line having a monitoring system in accordance with any of the above embodiments, and to monitoring methods using such systems.

The determination of the dimensions of the item to be monitored by the monitoring system so as to determine e.g. where to look for a glue track is itself an important feature, which need not be limited to determining the position of a glue track, but may be used to determine where to look for any feature of an item, whilst reducing the possibility for operator error.

The present invention therefore extends to a monitoring system for monitoring items on a production line, the system including camera means for providing one or more images of an item to be monitored, means for determining one or more dimensions of the item to be monitored, and means for controlling the camera means dependent on the determination of these dimensions. This then provides a system that is able to monitor items of varying dimensions, whilst reducing the possibility for human error in determining the position of the part of the item to be monitored and which type of item is being monitored.

Preferably, the system includes means for outputting said dimensions, e.g. onto a display screen, in order to obtain confirmation from e.g. an operator that the determined dimensions are acceptable. This is to guard against a situation in which for example the item being measured is itself defective.

Alternatively, an operator may input information regarding the item to be monitored, and the system may include means for checking this for consistency against the determined dimensions.

Further preferably, the control means includes offset data for determining the position of a monitored feature of the item based on the determined dimensions. This may for example comprise the offset position of a glue track from the edge of a blank flap or the position of a cut-out tab of the blank.

The above-mentioned rejection system is itself also a significant feature, and may be used in other situations also. Thus, the present invention extends to a system for rejecting an item from a production line, the system including monitoring means for determining whether an item is defective or not, e.g. through incorrect adhesive placement or the like, means for rejecting a defective item, and means for monitoring the movement of the defective item and for issuing an instruction to the rejecting means to reject the item when the defective item reaches the rejection means, e.g. before the item is stacked.

The invention also extends to systems for monitoring the presence or absence of a tab of e.g. a blank, and, from a further aspect provides a tab monitoring system for monitoring the removal of a tab from an item, e.g. a blank, wherein the system includes means for determining the position of the item on a production line, camera means for taking an image of a monitored item, means for triggering the camera means to take an image of the item at one or more set item positions, and processing means for analysing the images produced and for determining the correct removal of a tab from this analysis.

The present invention further extends to methods of monitoring and/or rejection using any of the above discussed monitoring and/or rejection systems.

Embodiments of the present invention will now be described, by way of example only, with reference to the accompanying drawings. It is to be understood that the particularity of the drawings does not supersede the generality of the preceding description of the invention.

In the drawings:

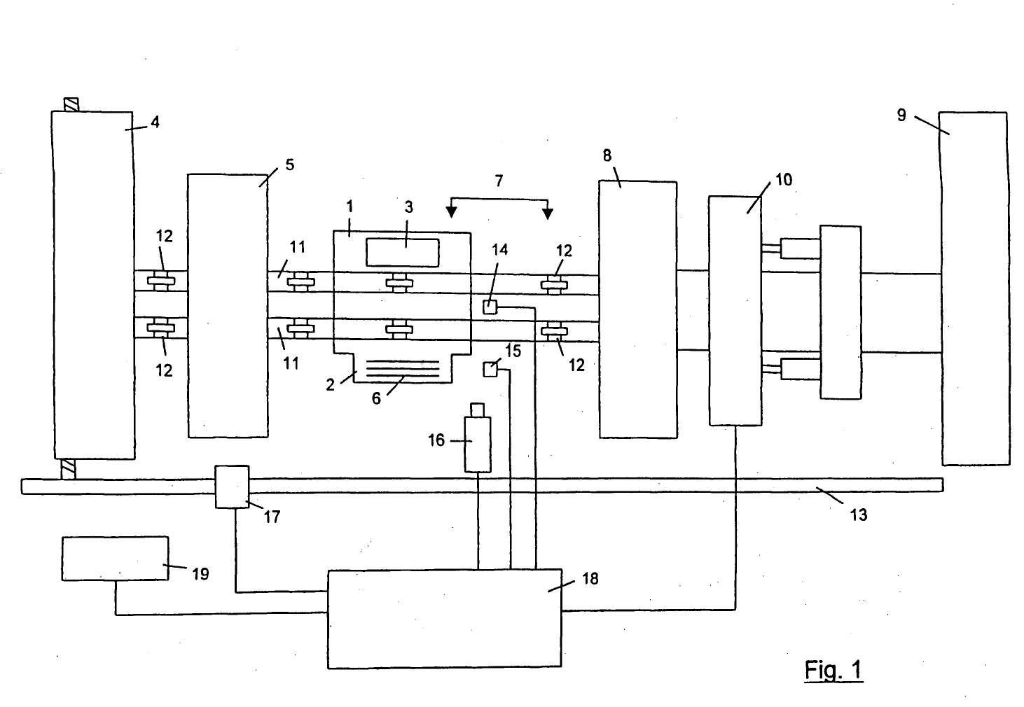

FIG. 1 is a schematic diagram of a cardboard box production line conveyor system in which is provided a monitoring system in accordance with an embodiment of the present invention;

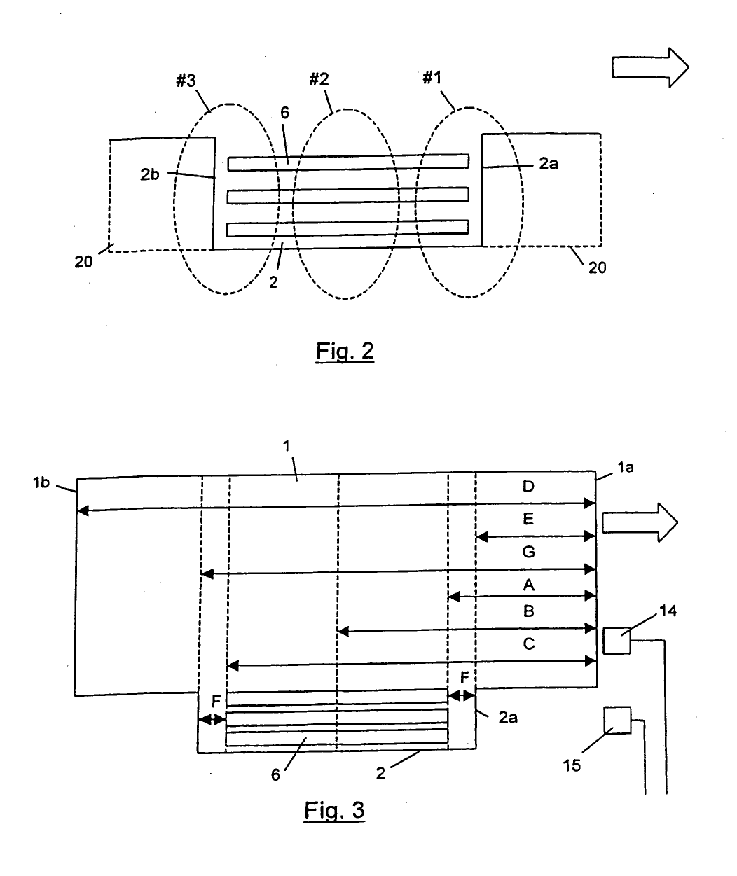

FIG. 2 is a detailed view of the areas of a box blank imaged by the monitoring system of FIG. 1;

FIG. 3 is a plan view of a box blank showing dimensions that are determined by the monitoring system in order to determine when to trigger a camera of the monitoring system to obtain the images of FIG. 2; and

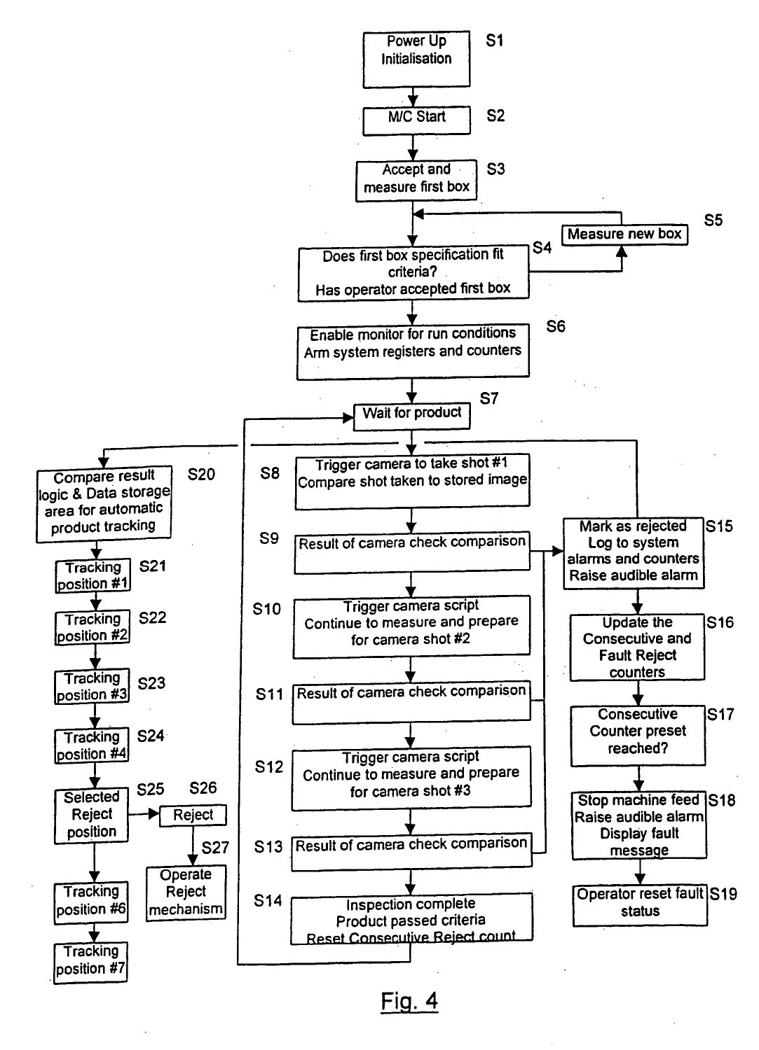

FIG. 4 is a flowchart of monitoring and rejection procedures used by the monitoring system of FIG. 1.

Referring to FIG. 1, an assembly line for constructing cardboard boxes from a plurality of cardboard blanks 1 is shown (not to scale).

The blanks 1 may take any suitable shape, in accordance with the box to be constructed, and may have one or more flaps which are glued to corresponding landing portions of the blank to form a box. A blank 1 with a single flap 2 and a corresponding landing zone 3 are shown as an example application.

The blank 1 is first cut from a web of cardboard by a rotary die cutting machine 4. It is then passed through a gluing station 5, where a plurality of parallel glue tracks 6 is applied to the flap 2.

Once the glue tracks 6 have been applied, the blank 1 passes through a monitoring area 7, where a check is made that the glue tracks 6 have been applied correctly.

The blank 1 then passes to a folding frame 8, as are know in the art, where the blank 1 is folded into a box shape, with the flap 2 being pressed against the landing portion 3 to form a suitable joint that will retain the box shape.

The resulting box is passed to a stacking and collating area 9, unless it failed the inspection in the monitoring area 7, in which case the box is rejected from the line by a rejection device 10 before it reaches the stacking and collating area 9.

The blank 1 may be conveyed along the production line by a pair of endless parallel webs 11 that press the blank 1 against another similar pair of webs on the opposite side of the blank 1. Free-wheeling pressure wheels 12 ensure that the webs 11 press against the blank 1, and are also provided at opposing positions on the opposite side of the blank 1. Any other suitable conveyor/feed system could also be used, and the line may be split into a number of separate conveyor/feed systems, e.g. so that one or more separate conveyor lines are provided after the folding frame 8.

The webs 11 and the rotary die cutting machine 4 are driven by a line shaft 13 at a suitable speed that may for example provide a blank movement of 5 metres per second or more if desired.

The monitoring system for checking the glue tracks 6 includes a sensor 14 for detecting a leading and trailing edge of the blank 1, a sensor 15 for detecting the leading and trailing edges of the flap 2, a camera 16 for taking images of portions of the blank 1, an encoder 17 for providing timing pulses associated with the movement of the conveyor line, a central controller 18 for overseeing the monitoring process, and an operator interface 19 for providing information to and receiving information from an operator of the system.

The gluing station 5 may include one or more glue heads for applying glue to the blank 1, and these may be movable to apply glue in different places. The monitoring equipment, such as the camera 16, and possibly, although not necessarily the sensors 14 and 15, may also move in correspondence with the glue heads of the glue station 5, so that the correct portions of the blank 1 are imaged. The glue heads and camera 16 may for example be mounted on the same mounting frame or otherwise physically connected together.

The sensors 14 and 15 may comprise photoelectric cells or any other suitable trigger switches. The controller 18 may comprise a Programmable Logic Controller (PLC), although it could comprise any other suitable computing apparatus, and the interface 19 may comprise a suitable display and keypad arrangement, which may for example be a touch screen.

The camera 16 may comprise a video camera, such as a CCD camera, and may for example comprise a SmartImage optical vision camera as manufactured by DVT Corporation of Georgia, USA.

The monitoring system works by taking images of areas of the blank 1 in which correctly applied glue tracks should be found. Thus, as shown in FIG. 2, the camera 16 may image areas #1, #2 and #3 of the blank 1 located at the leading edge, middle and trailing edge portions of the flap 2 respectively.

These images are then analysed to determine whether the glue tracks 6 have been properly applied.

The monitoring of the glue tracks 6 is carried out without stopping the production line, and the camera 16 takes the images #1, #2 and #3 sequentially, as the blank 1 moves along the conveyor line under the influence of the webs 11.

In order to obtain the images #1, #2 and #3, the controller 18 needs to know accurately the position of the blank 1, so that it can instruct the camera 16 when to take an image.

To do this, the controller 18 uses the blank and flap sensors 14,15 and the encoder 17.

When the blank 1 approaches the camera 16, its leading edge 1a triggers the sensor 14, which sends a signal to the controller 18. Once the sensor 14 has been triggered, the controller 18 counts the timing pulses from the encoder 17 (which will correspond to set travel distances), and will instruct the camera 16 to take an image when the number of pulses counted from the encoder 17 indicate that the blank 1 has moved distances A, B and C shown in FIG. 3 offset from the leading edge 1a of the blank 1. These distances correspond to the start, middle and end portions of the glue tracks 6.

The controller 18 may receive the offset values A, B and C from a direct input by an operator of the system through the interface 19. If, however, the operator inputs these values incorrectly, then a whole run of boxes could be lost, as could valuable production time.

To reduce the chances of human error, the controller 18 may instead include various stored dimensions, such as dimensions A, B and C, for set types of blank, in which case the operator need only input the blank type. Again, however, human error could occur through the input of a wrong blank type for the blank actually on the production line, and again this could cause lose of boxes and production time.

To avoid these problems, the controller 18 may determine the dimensions of the blank 1 itself through the inspection of an initial blank on the production line.

Thus, when the first blank 1 of a new run of blanks triggers the sensor 14, the controller 18 measures the distance D between the leading edge 1a of the blank 1 and the trailing edge 1b by counting the timing pulses from the encoder 17 between the time that the leading edge 1a triggers the sensor 14 and the time that the trailing edge 1b triggers the sensor 14.

The controller 18 also measures the distance E between the time that the leading edge 1a triggers the sensor 14 and the time that the leading edge 2a of the flap 2 triggers the sensor 15.

Assuming that the offset F of the glue tracks 6 from the leading and trailing edges 2a,2b of the flap 2 is always the same regardless of blank type, which will often be the case, then this value can be pre-stored in the controller 18.

From these readings, and assuming a symmetrical blank 1, the controller 18 can determine the distance A (=E+F) to the start of the glue tracks 6, the distance B (=D/2) to the middle of the glue tracks 6, and the distance C (=D−E−F) to the end of the glue tracks 6.

If the blank is not symmetrical, then other measurements may also be made. For example, if the flap 2 is forward or rearward of centre, then a further reading G could be obtained from the triggering of the sensor 15 by the trailing edge 2b of the flap 2.

By using this method to determine the correct positioning of the glue tracks 6 that are to be monitored, the opportunity for human error is greatly reduced, as the monitoring system itself determines the dimensions of the blank 1 and the expected positions of the glue tracks 6.

It may be that the first blank to reach the sensors 14,15 is defective in some manner, and so the controller 18 provides the operator with the chance to reject the measurements made and to take new measurements from another blank. It may do this by displaying the various dimensions on the user interface 19 and requiring the operator to accept or decline them.

Once a blank's dimensions have been accepted, the monitoring system becomes automatic. The system may shut down the feeding of blanks if no dimensions are accepted, so as to prevent blanks from being passed through the system without being monitoring.

As each blank 1 passes the camera 16, the controller 18 monitors the sensor 14 and the encoder 17 and instructs the camera to take an image of the blank 1 at three consecutive timings corresponding to the distances A, B and C so as to produce images #1, #2 and #3.

These images are analysed on the fly by processing means on the camera 16 or by the controller 18 to determine whether the tracks 6 have been correctly applied to the flap 2.

This analysis may be achieved by comparing the images taken by the camera 16 with pre-stored reference images of correctly positioned tracks.

These reference images may be the same for a number of different blank types, which for example only vary in length, as the start and end reference images will be the same for all blank lengths (comprising a start or end portion of the glue tracks, an offset, and the leading or trailing edge of the flap), and any intermediate reference images will be identical to one another (comprising three parallel tracks extending across the image).

The analysis and comparison may be carried out in any suitable manner, e.g. by determining intensity profiles along reference lines of the images and comparing these with intensity profiles of the same reference lines on the reference images.

Intensities may be measured against absolute values or may be measured relative to one another so as to reduce the influence of ambient light variations.

The analysis may also or alternatively count transitions between lighter and darker areas to provide edge information that can determine track and flap positions and the like, and may measure these in order to compare these measurements against reference values.

The analysis is able to accurately and reliably determine whether or not the glue tracks 6 have been correctly applied, and can determine not only whether the glue tracks exist and are continuous, but also whether too much glue has been applied and/or whether the glue extends too far to the end of the flap and the like.

The analysis can also determine the distance of the glue tracks 6 from the longitudinal edge of the flap, i.e. the edge parallel to the direction of movement of the blank. This enables the system to check for skewed glue tracks. These can occur when the glue station 5 uses heads that contact the blank 1, and when the blank 1 is not adequately pressured by the webs 11. In this case, the blank can turn slightly when contacted by the heads, and so the glue may be applied in a skewed fashion. Merely checking for parallel tracks would not identify this problem, as the tracks would all be parallel but skewed.

The analysis can further assess whether or not tabs 20 (shown in phantom in FIG. 2), which should have been cut out of the blank 1 to define the flap 2, have indeed been removed during the cutting process by the rotary die-cutting machine 4.

If the tabs have not been removed, the camera 16 will register an incorrect intensity profile as compared with that for a reference image of a blank with no tab attached. This may be through an increase or a decrease in image intensity in the expected region of the tab cut-out.

In this regard, it should be noted that the various timings for triggering the camera 16 are taken with respect to the leading edge 1a of the blank 1 rather than the leading edge 2a of the flap 2. This is because the leading flap edge 2a could have a tab still attached to it, and so could not guarantee a correct base point for the measurements.

Once the analysis is complete, the controller 18 will log whether or nor the blank 1 is a pass or a fail. If it is a fail, a suitable warning may issue, and the blank may be marked, e.g. with a suitable dye, so that it may be removed by an operator at the stacking and collating area 9.

Also or alternatively, the system may track the blank 1 and may automatically remove the box constructed from the rejected blank from the production line before it reaches the stacking area 9 by activating the rejection apparatus 10 at a suitable time.

Automatic removal of such boxes ensures that no defective boxes are sent out to a customer e.g. because an operator has not removed all of the dye-marked boxes from the collating area 9.

In the rejection process, the controller 18 notes a failed blank 1 in the monitoring area 7, and monitors the movement of the failed blank through the folding frame 8 to the rejection device 10 by counting the timing pulses from the encoder 17. When the failed blank 1, which is now folded into a box shape, reaches the rejection device 10, the controller 18 instructs the rejection device 10 to remove the folded blank from the production line.

This may be done by e.g. redirecting the box through the use of a push arm or the like. In a preferred construction, a trapdoor opens through which the box may fall into a reject bin.

By waiting for the blank 1 to be folded before removal, it may be more easily handled by the rejection device 10.

The system may record a pass or fail of the blank 1 as e.g. a “1” or a “0” in memory, and may move the record to a subsequent memory address on each timing pulse from the encoder or after a set number of timing pulses. In this way, the memory addresses may correspond to specific locations on the production line, and, on each timing pulse or set number of pulses, the system may check the memory location associated with the rejection apparatus 10, and activate the apparatus when a fail is recorded in that address.

FIG. 4 is a flowchart for the overall monitoring and rejection procedure.

After power up at step S1 and machine start at step S2, and as previously discussed, the monitoring system accepts and measures a first blank at step S3, in order to determine the blank dimensions and the expected positions of the glue tracks.

The dimensions are then displayed to the operator through the interface 19 at step S4 for confirmation that they are correct. If the operator rejects the dimensions, the system proceeds to step S5, where a new blank is measured.

Once the operator has accepted a set of blank dimensions, the system is suitably initialised for monitoring blanks of these dimensions at step S6, and the system then waits for the next blank to be registered by the sensor 14 at step S7. The system will prevent blank feed until the operator accepts a set of dimensions, so as to prevent the feeding of blanks without the initiation of the monitoring system.

When a blank 1 is detected, the controller 18 triggers the camera 16 a suitable time period after the detection so as to obtain the first image #1 of FIG. 2, at step S8. It also tells the camera 1 with which of its pre-stored reference images it should compare the obtained image, i.e. with a pre-stored area #1 reference image of a blank having correct glue track placement.

The camera 16 then carries out the comparison and issues a pass or fail signal to the controller 18 at step S9.

If the result is a pass, then the controller 18 triggers the camera 16 after a further suitable wait so that it takes an image of the second area #2 of FIG. 2, at step 10, and instructs the camera to compare this image with the correct reference image that corresponds to this area of the blank.

If the result of the comparison, at step S11, is a pass, then the controller 18, at step S12, triggers the camera a third time to take an image corresponding to area #3 of FIG. 2, and advises on the appropriate reference image with which it should be compared.

The camera 16 makes the comparison at step S13, and, if a pass, the inspection is complete at step S14, and the blank is considered to be acceptable for further processing. The process then returns to step S7 to wait for the next blank to trigger the sensor 14.

If the comparison at either of steps S9, S11 or S13 is a fail, then the controller 18 notes the blank as a reject, and this is logged into the system at step S15. At this stage, an alarm may issue to note the rejection, e.g. an audible alarm and/or an indication on the operator interface.

The controller 18 also increments a count of the number of consecutive failed comparisons at step S16, as well as a count of the type of failure found. Thus, running totals may be kept of the various types of failure encountered, e.g. the various types of glue track failures and/or flap errors, in order to aid in monitoring and control of the production line.

Next, at step S17, the controller 18 determines whether the consecutive count has reached a predetermined limit. If so, the controller 18 assumes that a problem has occurred and that an abnormal situation exists, e.g. with regard to the sensors 14,15 or the camera 16. It therefore issues an alarm, and stops the production line at step S18. The line remains halted until operator intervention resets the system at step S19.

It should be noted that the consecutive reject counter of step 16 will be cleared at step S14 when a blank has been passed as acceptable.

As well as checking for consecutive rejects and the like, when a failed blank is logged at step S15, the controller 18 also tracks the blank to a reject position.

Tracking is achieved, as said, by incrementing the address of each pass or fail record at every one or more set timing pulses, so that each memory address corresponds to a set tracking position on the production line and so that the records move through these addresses as the corresponding blanks move through the production line locations. Thus, at steps S20-25, the initial fail record recorded at step S15, is incremented in memory location, and on each occasion, the values of the various data storage addresses can be checked against the pass/fail data logic (e.g. a “1” or a “0”) to determine whether a pass or fail blank is at the associated line location.

When the blank 1 reaches the reject position corresponding to the reject apparatus 10, in this case tracking position #5 in step S25, the controller issues a command to the reject apparatus 10 to reject the blank currently at the apparatus at step 26, and the reject mechanism is operated at step S27.

Overall, the present invention provides a reliable and automated method of checking for appropriate glue track application and for rejecting defective product.

It is to be understood that various alterations, additions and/or modifications may be made to the parts previously described without departing from the ambit of the present invention, and that, in the light of the teachings of the present invention, the control system for analysing the images and the like may be implemented in software, firmware and/or hardware in a variety of manners as would be understood by the skilled man.

As an example of a possible alternative arrangement, instead of calculating all glue track positions and the like from an initial blank 1, the system could monitor various dimensions to itself identify the blank, and could then look up the associated pre-stored glue track offsets, camera firing points and the like for that blank type. Also, instead of using a set offset for the glue track from the flap leading edge, this could be determined from an analysis of a camera shot of the initial blank, and then accepted by the operator if correct. Reference images for comparison during monitoring could also be obtained at this point, or could be pre-stored in the system.

Also, instead of the glue tracks 6 being on the flap 2, the may be provided at other locations, such as on the land 3, in which case the camera 16 will need to be re-positioned to intercept those portions of the blanks 1 as they pass along the production line. As mentioned, the camera could be moved in correspondence with glue heads of the gluing station, e.g. by mounting them on the same mounting apparatus. Determining when to fire the camera could still be carried out in a similar manner to that described for the flap glue tracks 6, as the racks 6 will take on the same longitudinal position with respect to the leading edge 1a of the blank 1.

It should also be noted that obtaining the dimensions of the blank based on the first blank passed through the monitoring system is in itself an advantageous feature, that may be extended to other monitoring applications. It could for example apply to any monitoring system in which the monitoring system must have item dimensions in order to correctly trigger a camera to obtain images of appropriate portions of an item being monitored.

The monitoring system may be provided in a production line on construction or may be provided as a retrofit unit.

The rejection system could also be applied to other processes.

1. An adhesive monitoring system for monitoring the application of adhesive to an item, wherein the system includes means for determining the position of the item on a production line, camera means for taking an image of a monitored item, means for triggering the camera means to take an image of the item at one or more set item positions, and processing means for analysing the images produced and for determining the correct application of adhesive from this analysis.

2. The system of claim 1, wherein the processing means compares item images taken by the camera means with reference images.

3. The system of claim 1 or 2, wherein the processing means analyses the item images to recognise features within the item image.

4. The system of any preceding claim, wherein the processing means analyses the item images along one or more measurement lines.

5. The system of claim 4, wherein at least one of the measurement lines is in the direction in which the adhesive is applied to the item.

6. The system of claim 4 or 5, wherein at least one of the measurement lines is in a direction that is transverse to the direction in which the adhesive is applied to the item.

7. The system of any preceding claim, wherein the processing means monitors the length of an adhesive track applied to the item.

8. The system of any preceding claim, wherein the processing means monitors the width of an adhesive track applied to the item.

9. The system of any preceding claim, wherein the processing means monitors the number of adhesive tracks applied to the item.

10. The system of any preceding claim, wherein the processing means monitors the angle of application of an adhesive track applied to the item.

11. The system of any preceding claim, wherein the camera means takes an image at the expected start of an applied adhesive area, and at the expected end of an applied adhesive area.

12. The system of any preceding claim, wherein the camera means takes an image at one or more intermediate locations along an applied adhesive area.

13. The system of any preceding claim, wherein the item position determining means comprises means for determining when the item has reached a preset position, and wherein the triggering means triggers the camera means to take an image a set time after the item has reached the preset position.

14. The system of any preceding claim, including an encoder for monitoring the movement of a conveyor of the production line, wherein the item position determining means comprises means for determining when the item has reached a preset position, and wherein the triggering means triggers the camera means to take an image when the encoder indicates that the conveyor has moved a set distance since the item reached the preset position.

15. The system of any preceding claim, wherein the item is a blank, and wherein the processing means analyses the images taken to determine whether one or more blank tabs have been removed.

16. The system of any preceding claim, including means for allowing the camera means to move transverse to the production line.

17. The system of any preceding claim, wherein the camera means is connected in use with an adhesive application means and is movable with the same.

18. The system of any preceding claim, wherein when the processing means determines that adhesive was not correctly applied, the item is marked for removal purposes.

19. The system of any preceding claim, including means for tracking an item, and wherein when the processing means determines that adhesive was not correctly applied, the tracking means tracks the item for rejection.

20. The system of claim 19, wherein the tracking means monitors the amount of movement of a conveyor of the production line about its path.

21. The system of any preceding claim, wherein the system includes an encoder for monitoring movement of a conveyor of the production line, wherein the system records in a memory address a pass or fail for an item dependant on the analysis by the processing means, and wherein the system increments the address for each record in accordance with the output of the encoder, the addresses corresponding to set positions on the conveyor line.

22. The system of claim 21, wherein the system checks, at set intervals, the record held in a memory address associated with a rejection location of the conveyor line, and activates rejection apparatus when the record in that memory address indicates a fail.

23. The system of any preceding claim, including counter means for counting the number of items determined to have an incorrect application of adhesive.

24. The system of any preceding claim, including means for obtaining the dimensions of an item to be monitored by passing a correctly configured item through the monitoring system.

25. The system of claim 24, including sensor means for sensing leading and following edges of an item, and means for determining a dimension of the item from the sensing of the edges.

26. The system of any preceding claim, including a sensor for sensing leading and/or trailing edges of a flap portion of the item.

27. The system of claim 24, 25 or 26, wherein the system displays dimensional information, and allows an operator to confirm that the information is correct.

28. The system of claim 27, wherein the system uses the confirmed dimensional information to determine when to trigger the camera means.

29. The system of claim 28, wherein the system determines when to trigger the camera means based on the confirmed dimensional information and one or more offset values.

30. The system of any preceding claim, wherein the item is a blank having at least one flap, wherein the system determines dimensions of the blank, wherein the system includes a preset offset by which an adhesive track is to be inwardly spaced from the blank dimensions, and wherein the system calculates a start point of the adhesive track and an end point of the adhesive track, and activates the camera means to take an image of areas in which it is calculated that a correctly applied adhesive track should appear.

31. A production line having a monitoring system in accordance with any of the preceding claims.

32. An method of monitoring the application of adhesive to an item on a production line, including the steps of determining the position of the item on the production line, triggering a camera to take an image of a monitored item at one or more set item positions, and analysing the images produced to determine whether adhesive has been correctly applied to the item.

33. A monitoring system for monitoring items on a production line, the system including camera means for providing one or more images of an item to be monitored, means for determining one or more dimensions of the item to be monitored, and means for controlling the camera means dependent on the determination of these dimensions.

34. The system of claim 33, wherein the system includes means for outputting said dimensions, in order to obtain confirmation that the determined dimensions are acceptable.

35. The system of claim 34 or 35, wherein an operator inputs information regarding the item to be monitored, and the system includes means for checking the input information with the determined dimensions.

36. The system of claim 33, 34 or 35, wherein the control means includes offset data for determining the position of a monitored feature of the item based on the determined dimensions.

37. The system of claim 36, wherein the offset data is the offset position of an adhesive track from the edge of a blank flap or the position of a cut-out tab of a blank.

38. A system for rejecting an item from a production line, the system including monitoring means for determining whether an item is defective or not, means for rejecting a defective item, and means for monitoring the movement of the defective item and for issuing an instruction to the rejecting means to reject the item when the defective item reaches the rejection means.

39. A tab monitoring system for monitoring the removal of a tab from an item, wherein the system includes means for determining the position of the item on a production line, camera means for taking an image of a monitored item, means for triggering the camera means to take an image of the item at one or more set item positions, and processing means for analysing the images produced and for determining the correct removal of a tab from this analysis.

40. A monitoring system substantially as hereinbefore described with reference to the accompanying drawings.

41. A monitoring method substantially as hereinbefore described with reference to the accompanying drawings.

42. A production line substantially as hereinbefore described with reference to the accompanying drawings.
